(19) United States
(12) Patent Application Publication
(10) Pub. No.: US 2006/0014411 A1
(43) Pub. Date: Jan. 19, 2006

(54) Cord coupler

(76) Inventor: John Patrick Stair, Hayesville, NC (US)

Correspondence Address: JOHN STAIR, PO BOX 773, 374 PINNEY RD, HAYESVILLE, NC, 28904, US

(21) Appl. No.: 10/892,042

(22) Filed: Jul. 14, 2004

(51) Int. Cl. H01R 13/52

(52) U.S. Cl. 439/271

(57) ABSTRACT

A cord coupler comprised of an elongated elastic, or stretchable tubular body, open at both ends. The primary use of this unit is to keep the mating of electrical cord type connections. Having the ends so constructed to form a slight roll which purpose is to be able to Roll-back-onto-itself feature for easy connect or disconnect of electrical connection. This unit also is nearly water tight because of its elastic material.

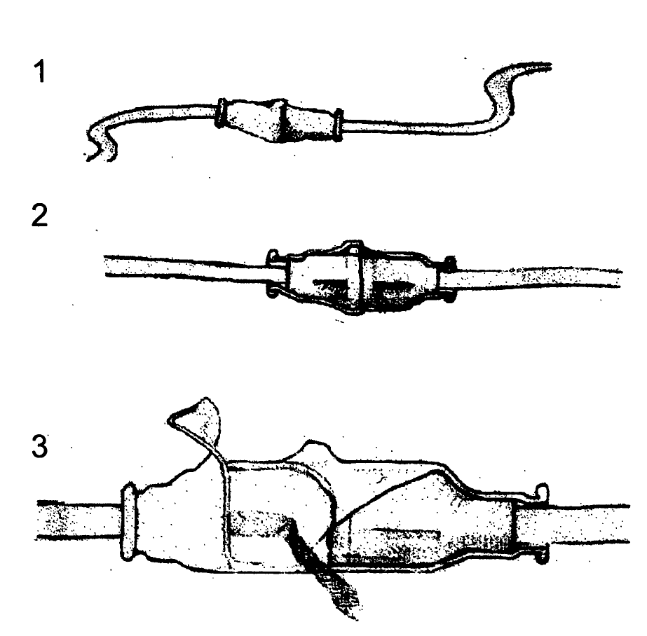

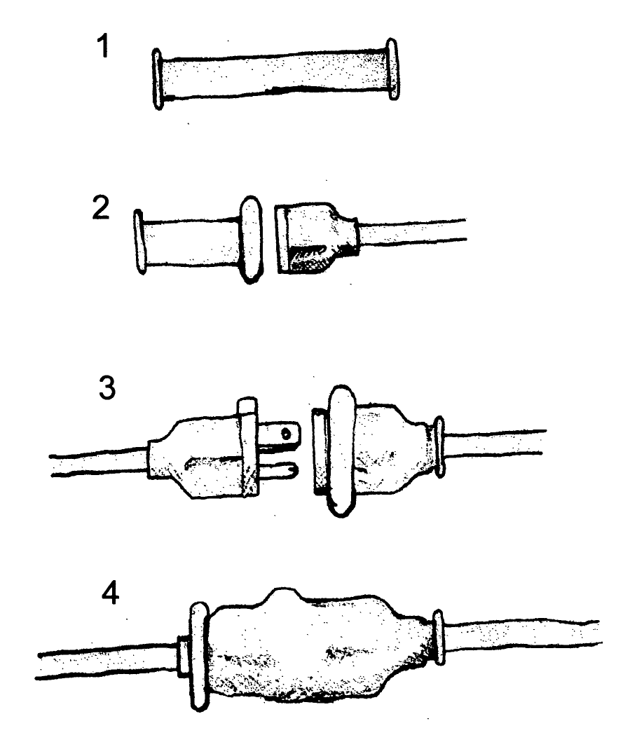

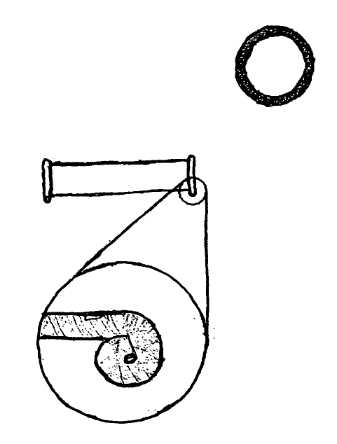

### BRIEF DESCRIPTION OF DRAWINGS

Page 1 drawing number 1: Cord coupler fully connected surrounding electrical cords.

Page 1 dawing number 2: Cord coupler xray typeview showing the connection of electrial cords.

Page 1 drawing number 3: Cut away view of cord connector with fiber type substance added if needed for extra strength.

Page 2 drawing number 1: Cord coupler in a non used or starter state of the process of using unit.

Page 2 drawing number 2: Cord coupler partically rolled back unto itself.

Page 2 drawing number 3: Cord coupler attached to 1st electrical cord and still rolled up, ready to incorporate 2nd electrial cord.

Page 2 drawing number 4: Cord connector almost fully rolled and incorporating both electrical cords.

### DETAILED DESCRIPTION

This cord coupler allows for connecting male to female or reverse, electrical cords of any nature. Cord connector is made from elastic or strechable, substance, having a tubular design. THE ENDS ARE OPEN< and so constructed as to have a tapered fit. Each end has a slight rolled edge, as to allow for simple rolling up onto itself, for quick effortless connection. The strechable tubular design allows for a tapered fit in the middle section as to allow for more strechable strength, to keep cords connected, held securely, but not permanent in place. This cord connector is of an elastic substance which contours to almost all cords, to create a nearly water tight seal, threfore greatly reducing G.F.I. (Ground Fault Interrupters), trip or disconnect. If this unit is used in a wet, muddy condition, that stepping, or hang-ups, the user would be able to pull the cord free from most all above, and not have a disconnect. The unit is virtually hang-up free because of its elastic properties it dosen't scratch, or damage finished and non finished surfaces, where as other simular products hang-up, or snag, or do damage because of protruding appendages, or abrasiveness of the material of their construction. This unit can be used with any, or almost any, electrical extension cords, but not limited to only extension cords. Any devise (drill, skill saw, or other power tool) can be picked up without disconnection of power. Where as the strechable substance will retain its original form and keep the matng of electrical connection.

Another unique feature of this design, compared to others, is the easy roll up design feature. That keeps cords attached together (semi-permanent) that can endure physical pulling of electrical cord. That allows for some pulling presssure and not have a disconnect, and also retain its original form in the case of excess pulling. Tapered fit in the middle of the unit, to help in mating of male to female extension cords, can have a fiber type substance added to provide more strength and retain connection properties. Environmentally friendly and biodegradable, when produced from natural latex.

1. A flexible protective seal for the interconnection of a male and female type electrical cord. THE SAID UNIT IS USUALLY TUBULAR IN DESIGN< and open at either end, as to allow to incorporate the male and female electrical plug.

2. Rolled lip at either end for Roll-onto-itself quick connect and disconnect.

3. Nearly waterproof qualities.

4. In accordance with claim 1, an improved cord connector, unit is of rubber or elastic, stretchable type which allows for said design.

5. In accordance with claim 1, an improved cord connector, that unit is of one piece as to allow for semi permanent connection of an electrical cord. To pull the cord free from almost any circumstance and not have a disconnect.

6. In accordance with claim 1, an improved cord connector, unit is designed to allow for normal impact, and not sustain major injuries to said unit.

7. In accordance with claim 1, an improved cord connector, that reduces the risk of electrocution or premature disconnect.

8. In accordance with claim 1, an improved cord connector, that hang-ups or pull-outs will be eliminated, due to its tubular design and no protruding parts.

9. In accordance with claim 1, an improved cord connector, will not scratch or damage finished and non finished surfaces because of its elastic qualities.

10. In accordance with claim 1, an improved cord connector, because of its design, the unit wont twist or bind the electrical cords in any way, other than normal handling of cords would result in.

11. In accordance with claim 1, an improved cord connector, because of its elastic substance, that conforms to electrical cords unit will virtually eliminate G.F.I (Ground Fault Interrupters), trip and or disconnect.

12. In accordance with claim 1, an improved cord connector, because of its elastic, tubular design unit will contour on almost all common electrical cords of today.

13. In accordance with claim 1, an improved cord connector, because of the unit design, the unit allows for easy viewing of a correct connection with out exposing electrical terminals.

14. In accordance with claim 1, an improved cord connector, unit has no appendage or entrap mental design as to allow for foreign material to enter said unit because its contoured smooth, elastic design.

15. In accordance with claim 1, an improved cord connector, because of its elastic, rubber like qualities that if unit were made from natural latex, or natural elastic substance, the unit would be environmentally friendly and biodegradable.

16. In accordance with claim 2, an easy connect disconnect feature, which has a rolled lip at either end to allow for simple Roll-onto-itself feature, that the user would be able to roll up the elastic substance with ease and quickness.

17. In accordance with claim 3, nearly waterproof qualities, although the unit is not 100 percent water tight, that unit would repel water in most situations.

18. In accordance with claim 3, nearly waterproof qualities, unit will not allow for foreign substances (dirt, mud, sand, grit, possibly oils, petroleum, ect.) to penetrate unit and allow for improper connection and reduce the risk of electrical shock.
